(19) United States
(12) Patent Application Publication
(10) Pub. No.: US 2014/0146639 A1
(43) Pub. Date: May 29, 2014

(54) DETECTION OF SUBTERRANEAN VOIDS

(71) Applicant: RAYTHEON COMPANY, Waltham, MA (US)

(72) Inventors: Theodore J. Vornbrock, Takoma Park, MD (US); Aaron M. Foulk, Woodbridge, VA (US); Nelson A. Gomez, Stafford, VA (US); Jessee L. Kopczynski, Fairfax, VA (US); Mark Olender, Alexandria, VA (US); Richard Pitre, Carbondale, CO (US)

(73) Assignee: RAYTHEON COMPANY, Waltham, MA (US)

(21) Appl. No.: 13/688,628

(22) Filed: Nov. 29, 2012

(51) Int. Cl. G01V 1/30

(52) U.S. Cl. CPC G01V 1/301
USPC 367/25

(57) ABSTRACT

A system for detecting subterranean voids includes a sensor array disposed in a subterranean location, an energy emitting device disposed on a position on a surface of terrain, the energy emitting device operative to emit wave patterns that propagate in a subterranean region proximate to the energy emitting device, and a control system communicatively connected to the sensor array, the control system operative to receive signals from the sensor array indicative of the direction and intensity of wave patterns emitted from the energy emitting device and output an indication to a user indicative of the location of a subterranean void.

### BACKGROUND

The present invention relates to subterranean void detection.

Subterranean voids such as, for example, tunnels or pipes may be detected using acoustic or seismic sensors that often detect the voids by sensing vibratory or acoustic emissions from the voids. For example, tunnels have been located by sensors detecting the noises and vibrations caused by the construction of the tunnels or activities in the tunnel such as movement of materials or personnel through the tunnels or the operation of machinery such as pumps or ventilation fans in the tunnels.

### SUMMARY

According to one embodiment of the present invention, a system for detecting subterranean voids includes a sensor array disposed in a subterranean location, an energy emitting device disposed on a position on a surface of terrain, the energy emitting device operative to emit wave patterns that propagate in a subterranean region proximate to the energy emitting device, and a control system communicatively connected to the sensor array, the control system operative to receive signals from the sensor array indicative of the direction and intensity of wave patterns emitted from the energy emitting device and output an indication to a user indicative of the location of a subterranean void.

According to another embodiment of the present invention, a method for detecting a subterranean void includes emitting a wave pattern at a first terrain surface position that propagates through terrain proximate to the first terrain surface position, detecting the wave pattern with a subterranean sensor array, receiving signals from the sensor array indicative of the intensity of wave patterns emitted from the energy emitting device, and outputting an indication to a user indicative of the location of a subterranean void on a display.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a detection system.

FIG. 2 illustrates a block diagram of an exemplary embodiment of the control system of FIG. 1.

FIG. 3 illustrates a graphical representation of a modeled wave pattern.

FIG. 4 illustrates another graphical representation of a modeled wave pattern.

FIG. 5 illustrates a plurality of intensity graphs representing a plurality of graphical outputs of the system of FIG. 1.

FIG. 6 illustrates a block diagram of an exemplary method for operating the system of FIG. 1.

### DETAILED DESCRIPTION

Subterranean voids such as, for example, tunnels or pipes have previously been detected by seismic or acoustic sensors that detect the activities in the tunnels during construction of the tunnels, the movement of personnel or materials through the tunnels, or the operation of machinery such as, pumps or ventilation systems in the tunnels. Such systems are “passive” systems in that the detection systems do not emit signals, but rather passively detect emissions from the tunnels.

If the tunnels are quiet or dormant, the passive systems will not sense the tunnels. The exemplary embodiments described below offer a system and method for detecting subterranean voids that may be either quiet or dormant.

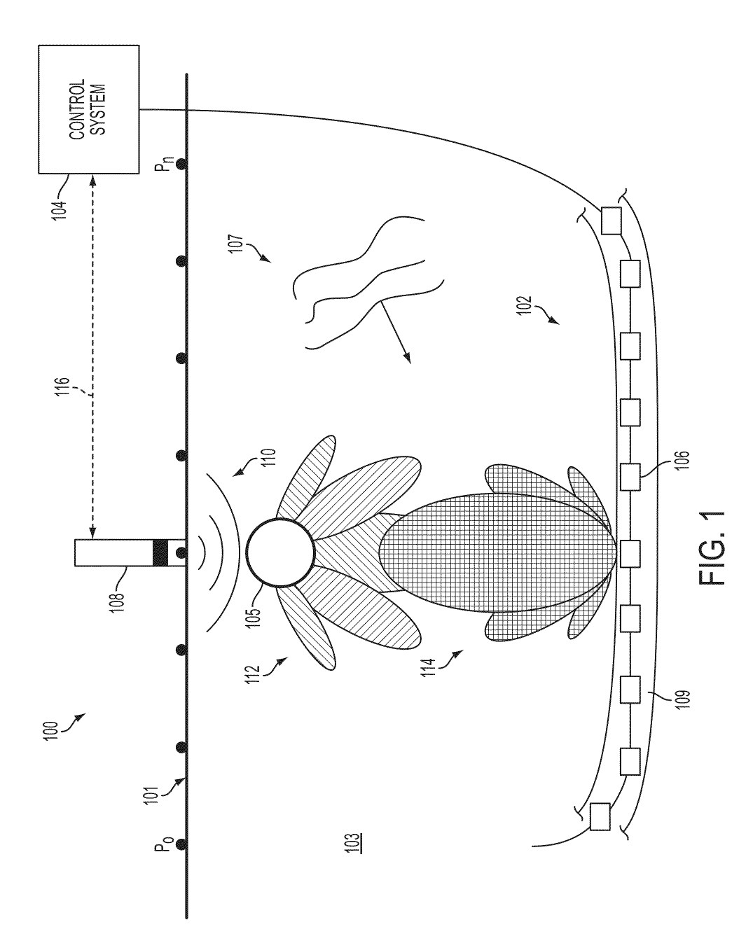

In this regard, FIG. 1 illustrates a detection system (system) 100. The system 100 includes a sensor array 102 that includes a plurality of sensors 106. The sensors 106 may include, for example, acoustic or seismic sensors such as hydrophones or geophones. The sensor array 102 is arranged in a subterranean bore hole 109 in a subsurface 103. The sensor array 102 is communicatively connected to a control system 104 that will be described in further detail below. The system 100 includes an energy emission device 108 that is arranged on the surface 101. The energy emission device 108 may be communicatively connected to the control system 104, via a communications connection 116, which in some embodiments may include a verbal or visual communication method or device to facilitate communications between an operator of the energy emission device 108 and an operator of the control system 104. The energy emission device 108 may include any device that is operative to generate a subterranean vibration or sound such as, for example a modified mechanical tool such as a pneumatic jackhammer, or an acoustic generating device. The sensor array 102 is positioned such that a void or tunnel 105 is disposed between the surface 101 and the sensor array 102. Though the illustrated embodiment shows a sensor array 102 that is disposed in a substantially horizontal bore hole 109, alternate embodiments of the sensor array 102 may include sensors 106 disposed in an arrangement of vertical bore holes such that the depth of the sensors 106 is greater than the depth of the tunnel 105 relative to the surface 101.

In operation, the energy emission device 108 is placed in a position (P) and is operated to cause vibratory or acoustic signals 110 or wave patterns that emanate from the position P. The sensors 106 of the sensor array 102 are operative to sense the signals 110 that emanate from the energy emission device 108. The characteristics of the signals 110 are changed by impinging on the tunnel 105, which results in the diffraction of the signals 110 and a shadow zone 112 disposed generally between the tunnel 105 and the sensor array 102 that may be detected by the sensor array 102. The energy emission device 108 may be positioned in various positions (Pₙ) such that the sensor array 102 may compare the sensed signals 110 from the energy emission device 108 disposed in different positions. The comparison of the sensed signals 110 from various positions facilitates the determination of the position of the tunnel 105.

The system 100 is operative to process the signals received from the sensor array 102 and output a delay-and-sum beamformer output using a sub-aperture beam pattern 114. The sensor array 102 may also process and filter noise signals 107 that may result from surface vibrations or noise emissions. The beamformer pattern 114 represents the directional sensitivity of the sensor array 102 to the arrival of energy from signals 110 and noise signals 107. Through beamformer analysis by control system 104 of the arrival times of signals 110 and noise signals 107 measured by the individual sensors 106 in sensor array 102, the direction relative to the array 102 from which the signals arrive may be determined. The control system 104 may impose relative time delays in the analysis of the signals measured by the individual sensors 106 in sensor array 102, and the direction of greatest sensitivity of beamformer pattern 114 may be shifted to enable more accurate directional determination of signals 110 and noise signals 107.

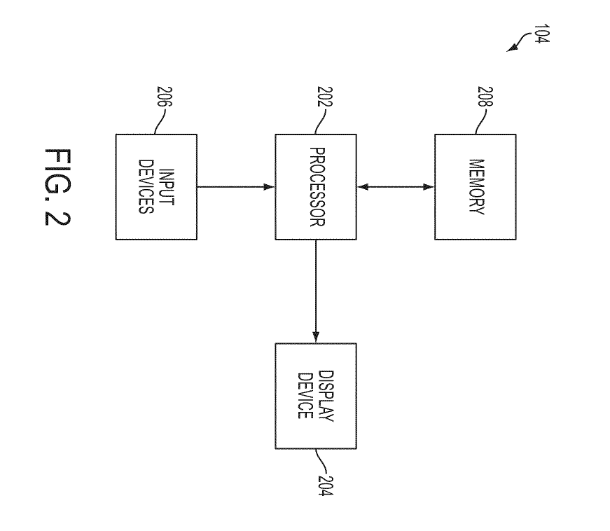

FIG. 2 illustrates a block diagram of an exemplary embodiment of the control system 104. The control system 104 includes a processor 202 that is communicatively connected to a display device 204, input devices 206 that include the sensor array 102 (of FIG. 1, and a memory device 208. In operation, the control system 104 may receive indications of the location of the energy emission device 108 (e.g., global positioning system coordinates). The control system 104 receives signals output by the sensor array 102 and processes the signals to output a graphical plot of the signals sensed by the sensor array 102. The energy emission device 108 (of FIG. 1), may be communicatively connected and controlled by the control system 104, or in alternate embodiments, the energy emission device 108 may be controlled by an operator who coordinates the operation of the energy emission device 108 with the operator of the control system 104 using verbal or visual communication methods.

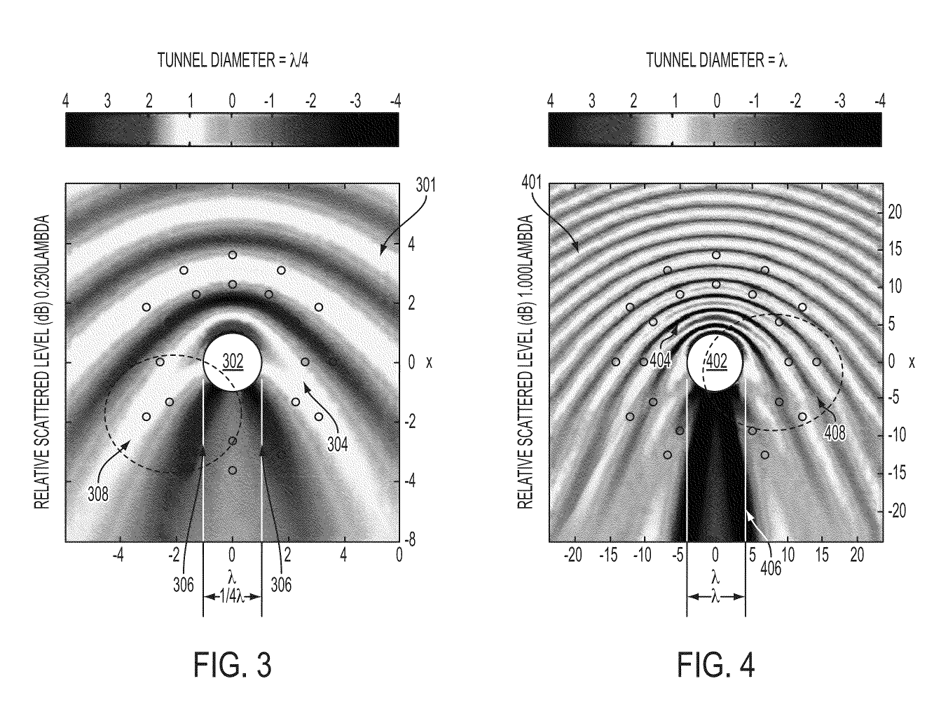

FIG. 3 illustrates a graphical representation of a modeled wave pattern 301 that impinges on a simulated tunnel (void) 302 having a diameter that equals ¼ the wavelength (λ) that is emitted by a simulated vibration generating device similar to the device 108 (of FIG. 1). A specular scattering or refraction region 304 is exhibited as well as a shadow zone 306. The tunnel 302 also affects the diffraction of the wave pattern exhibited in the region 308.

FIG. 4 illustrates a graphical representation of a modeled wave pattern 401 that impinges on a simulated tunnel (void) 402 having a diameter that equals the wavelength (λ) that is emitted by a modeled vibration generating device similar to the device 108 (of FIG. 1). A specular scattering or refraction region 404 is exhibited as well as a shadow zone 406. The tunnel 402 also affects the diffraction of the wave pattern exhibited in the region 408. When the wavelength is closer to the diameter of the tunnel 402 (e.g., tunnel diameter equals λ as opposed to the tunnel diameter equaling λ/4), the definition of shadow zone 406 is improved due to a reduction of the diffraction of the wave pattern.

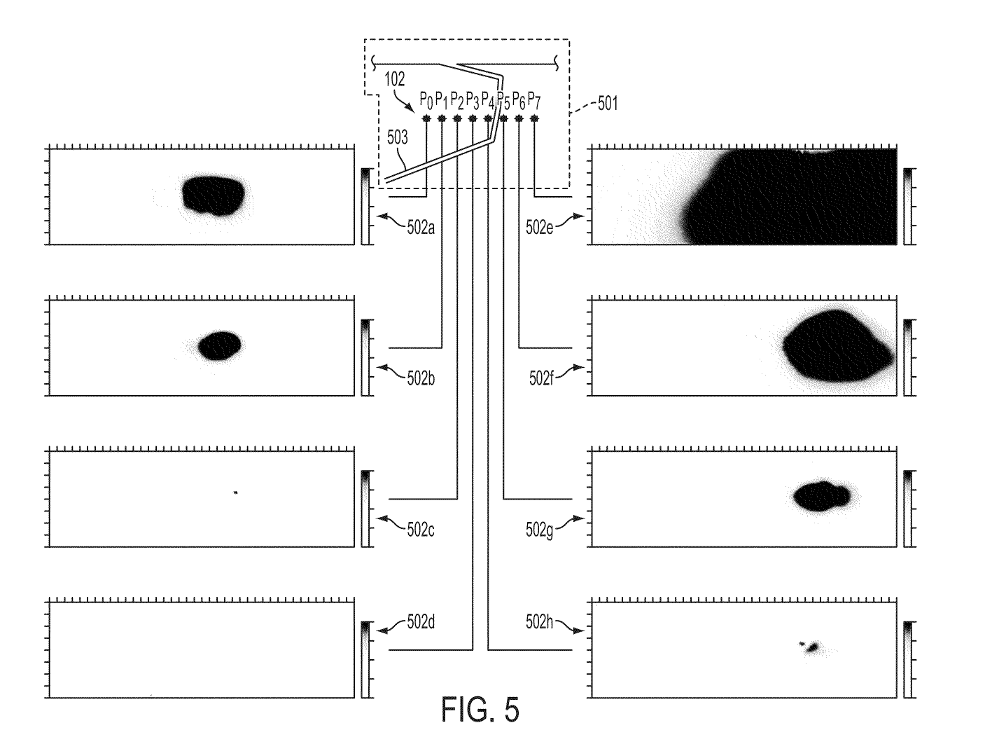

FIG. 5 illustrates a plurality of intensity graphs 502 representing a plurality of graphical outputs of the system 100 (of FIG. 1) that may be presented to a user on the display device 204 (of FIG. 2). In this regard, each screen shot represents a plot of the signals sensed by the sensor array 102 with the energy emission device 108 (of FIG. 1) located at a plurality of geographic positions Pₙ. The geographic positions are shown plotted on a plan or map of terrain 501. The map 501 also shows a graphical representation of the projection of a subterranean tunnel 503 (void or tunnel 105). The sensor array 102 shown in map 501, is arranged at a depth below the tunnel 503. The intensity graphs 502 include a vertical axis representing the orthogonal distance from a reference line drawn through the elements of the sensor array 102 in meters and a horizontal axis representing relative distance along a reference line from a sensor 106 arranged in position P₀ drawn through the elements of the sensor array 102. The third dimension is oriented into the page and represents the downward distance from the local surface. Thus, each of the intensity plots corresponds to a plan view of the intensity in a plane of fixed depth generated by energy emission device 108 (of FIG. 1) at Position Pₙ on the surface. Increased intensity of the sensed energy is represented by lighter shaded regions of the graphs, and is particularly apparent in the graphs 502a, 502b, 502e, 502f, and 502g. The reduction in intensity in graphs 502c, 502d and 502h is indicative of the location of the tunnel 503 due to the creation of shadow zones 306 (FIGS. 3) and 406 (FIG. 4). Thus, an operator may monitor the graphical outputs of the system 100 on the display device 204 and determine the presence and approximate location including the depth of a subterranean void or tunnel.

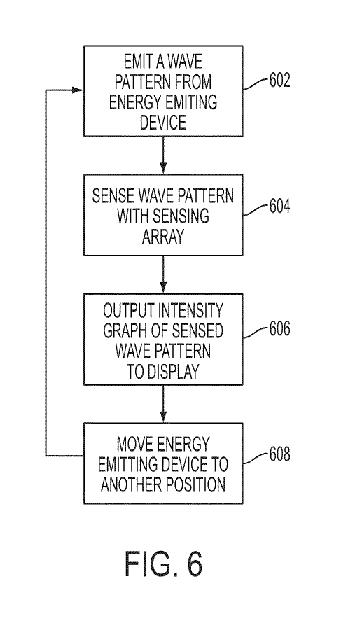

FIG. 6 illustrates a block diagram of an exemplary method for operating the system 100 (of FIG. 1). Referring to FIG. 6, in block 602 the energy emitting device 108 emits a wave pattern. The wave pattern is sensed with the sensing array 102 in block 604. In block 606, an intensity graph is output to the display device 204 (of FIG. 2). In block 608, the energy emitting device may be moved to another position. Once a series of intensity graphs 502 (FIG. 5) is produced to encompass the subsurface region covered by sensing array 102, the intensity graphs 502 are analyzed to infer the presence or absence of buried voids within the subsurface region.

Technical effects and benefits of the described exemplary embodiments include a detection system using an active detection system and method that is capable of detecting subterranean voids or tunnels that are dormant or emit little detectible energy.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A system for detecting subterranean voids, the system comprising:
a sensor array disposed in a subterranean location;
an energy emitting device disposed on a position on a surface of terrain, the energy emitting device operative to emit wave patterns that propagate in a subterranean region proximate to the energy emitting device; and
a control system communicatively connected to the sensor array, the control system operative to receive signals from the sensor array indicative of the direction and intensity of wave patterns emitted from the energy emitting device and output an indication to a user indicative of the location of a subterranean void.

2. The system of claim 1, wherein the indication to the user indicative of the location of the subterranean void is includes intensity plot graph.

3. The method of claim 2, wherein the intensity plot graph indicates an approximate subterranean depth of the void.

4. The system of claim 1, wherein the sensor array includes a plurality of hydrophones.

5. The system of claim 1, wherein the sensor array includes a plurality of geophones.

6. The system of claim 1, wherein the sensor array is disposed in at least one subterranean borehole.

7. The system of claim 1, wherein the control system includes a display operative to output the indication to the user indicative of the location of the subterranean void.

8. The system of claim 1, wherein the subterranean void is disposed at a subterranean depth that is less than a subterranean depth of the sensor array.

9. The system of claim 1, wherein the subterranean void is a tunnel.

10. The system of claim 1, wherein the control system is operative to analyze the signals received from the sensor array using a beamformer analysis.

11. A method for detecting a subterranean void, the method comprising:
emitting a wave pattern at a first terrain surface position that propagates through terrain proximate to the first terrain surface position;
detecting the wave pattern with a subterranean sensor array;
receiving signals from the sensor array indicative of the intensity of wave patterns emitted from the energy emitting device; and
outputting an indication to a user indicative of the location of a subterranean void on a display.

12. The method of claim 11, wherein the method further comprises:
emitting a wave pattern at a second terrain surface position that propagates through terrain proximate to the second terrain surface position;
detecting the wave pattern with a subterranean sensor array;
receiving signals from the sensor array indicative of the intensity of wave patterns emitted from the energy emitting device;
outputting a second indication to a user indicative of the location of a subterranean void on a display.

13. The method of claim 11, wherein the method further comprises disposing the sensor array in at least one subterranean bore hole prior to emitting the wave pattern at the first terrain surface position.

14. The method of claim 11, wherein the sensor array includes a plurality of hydrophones.

15. The method of claim 11, wherein the sensor array includes a plurality of geophones.

16. The method of claim 10, wherein the sensor array is disposed at a subterranean depth greater than the depth of the subterranean void.

17. The method of claim 11, wherein the signals are received by a processor.

18. The method of claim 11, wherein the indication to the user indicative of the location of the subterranean void includes an intensity plot graph.

19. The method of claim 18, wherein the intensity plot graph indicates an approximate subterranean depth of the void.

20. The method of claim 11, wherein the wave pattern at a first terrain surface position that propagates through terrain proximate to the first terrain surface position is emitted from an energy emission device.
